(19) United States
(12) Patent Application Publication
(10) Pub. No.: US 2018/0037207 A1
(43) Pub. Date: Feb. 8, 2018

(54) VEHICLE BRAKE-BY-WIRE SYSTEM WITH A BRAKE PEDAL EMULATOR OVERRIDE DEVICE

(71) Applicant: GM GLOBAL TECHNOLOGY OPERATIONS LLC, Detroit, MI (US)

(72) Inventors: Brandon C. Pennala, Howell, MI (US); Michael C. Roberts, Auburn Hills, MI (US); Christopher C. Chappell, Commerce Township, MI (US)

(21) Appl. No.: 15/230,657

(22) Filed: Aug. 8, 2016

(51) Int. Cl. B60T 13/74; B60T 7/06; B60T 7/04

(52) U.S. Cl. CPC B60T 13/746; B60T 7/042; B60T 7/06; B60T 2270/82; B60T 2270/404

(57) ABSTRACT

A brake pedal apparatus for actuating a vehicle brake assembly includes a stationary structure, a brake pedal emulator assembly, and an emulator override device. The brake pedal emulator assembly includes a brake pedal operatively engaged to the stationary structure, and a brake pedal emulator operatively engaged between the stationary structure and the brake pedal along a centerline. The brake pedal emulator is configured to electrically operate the brake assembly. The emulator override device includes a mechanical linkage operatively engaged to the brake assembly, and a latch configured to selectively connect and disconnect the mechanical linkage from the brake pedal emulator assembly. The mechanical linkage is configured to mechanically operate the brake assembly via at least in-part movement of the brake pedal along the centerline.

### FIELD OF THE INVENTION

The subject invention relates to a vehicle brake-by-wire (BBW) system, and more particularly, to a brake pedal emulator with an emulator override device.

### BACKGROUND

Traditional service braking systems of a vehicle are typically hydraulic fluid based systems actuated by a driver depressing a brake pedal that generally actuates a master cylinder. In-turn, the master cylinder pressurizes hydraulic fluid in a series of hydraulic fluid lines routed to respective actuators at brakes located adjacent to each wheel of the vehicle. Such hydraulic braking may be supplemented by a hydraulic modulator assembly that facilitates anti-lock braking, traction control, and vehicle stability augmentation features. The wheel brakes may be primarily operated by the manually actuated master cylinder with supplemental actuation pressure gradients supplied by the hydraulic modulator assembly during anti-lock, traction control, and stability enhancement modes of operation.

When a plunger of the master cylinder is depressed by the brake pedal to actuate the wheel brakes, pedal resistance is encountered by the driver. This resistance may be due to a combination of actual braking forces at the wheels, hydraulic fluid pressure, mechanical resistance within the booster/master cylinder, the force of a return spring acting on the brake pedal, and other factors. Consequently, a driver is accustomed to and expects to feel this resistance as a normal occurrence during operation of the vehicle. Unfortunately, the ‘feel’ of conventional brake pedals are not adjustable to meet the desires of a driver.

More recent advancements in braking systems include BBW systems that actuate the vehicle brakes via an electric signal typically generated by an on-board controller. Brake torque may be applied to the wheel brakes without a direct hydraulic link to the brake pedal. The BBW system may be an add-on, (i.e., and/or replace a portion of the more conventional hydraulic brake systems), or may completely replace the hydraulic brake system (i.e., a pure BBW system). In either type of BBW system, the brake pedal ‘feel’, which a driver is accustomed to, must be emulated.

Accordingly, it is desirable to provide a brake pedal emulator that may simulate the brake pedal ‘feel’ of more conventional brake systems, and an emulator that is generally robust.

### SUMMARY OF THE INVENTION

In one exemplary embodiment of the invention, a brake pedal apparatus for actuating a vehicle brake assembly includes a stationary structure, a brake pedal emulator assembly, and an emulator override device. The brake pedal emulator assembly includes a brake pedal operatively engaged to the stationary structure, and a brake pedal emulator operatively engaged between the stationary structure and the brake pedal along a centerline. The brake pedal emulator is configured to electrically operate the brake assembly. The emulator override device includes a mechanical linkage operatively engaged to the brake assembly, and a latch configured to selectively connect and disconnect the mechanical linkage from the brake pedal emulator assembly. The mechanical linkage is configured to mechanically operate the brake assembly via at least in-part movement of the brake pedal along the centerline.

In another exemplary embodiment of the invention, a vehicle includes a BBW system that has a brake assembly, a brake pedal emulator assembly and an emulator override device. The brake pedal emulator assembly is electrically connected to the brake assembly and the emulator override device is mechanically connected to the brake assembly.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic plan view of a vehicle having a BBW system as one non-limiting example in accordance with the present disclosure;

FIG. 2 is a schematic of the BBW system;

FIG. 3 is a schematic of a brake pedal apparatus of the BBW system;

FIG. 4 is a graph of a force profile of a force induction device of the BBW system as a function of brake pedal travel;

FIG. 5 is a graph depicting a damping coefficient profile as a function of brake pedal travel;

FIG. 6 is a schematic of the brake pedal apparatus in a BBW mode and without actuation of a brake pedal;

FIG. 7 is a schematic of the brake pedal apparatus in the BBW mode and with actuation of the brake pedal;

FIG. 8 is a schematic of the brake pedal apparatus in a mechanical backup mode and without actuation of the brake pedal;

FIG. 9 is a schematic of the brake pedal apparatus in the mechanical backup mode and with actuation of the brake pedal;

FIG. 10 is a schematic of a second embodiment of the brake pedal apparatus; and

FIG. 11 is a schematic of a third embodiment of the brake pedal apparatus.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the terms module and controller refer to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

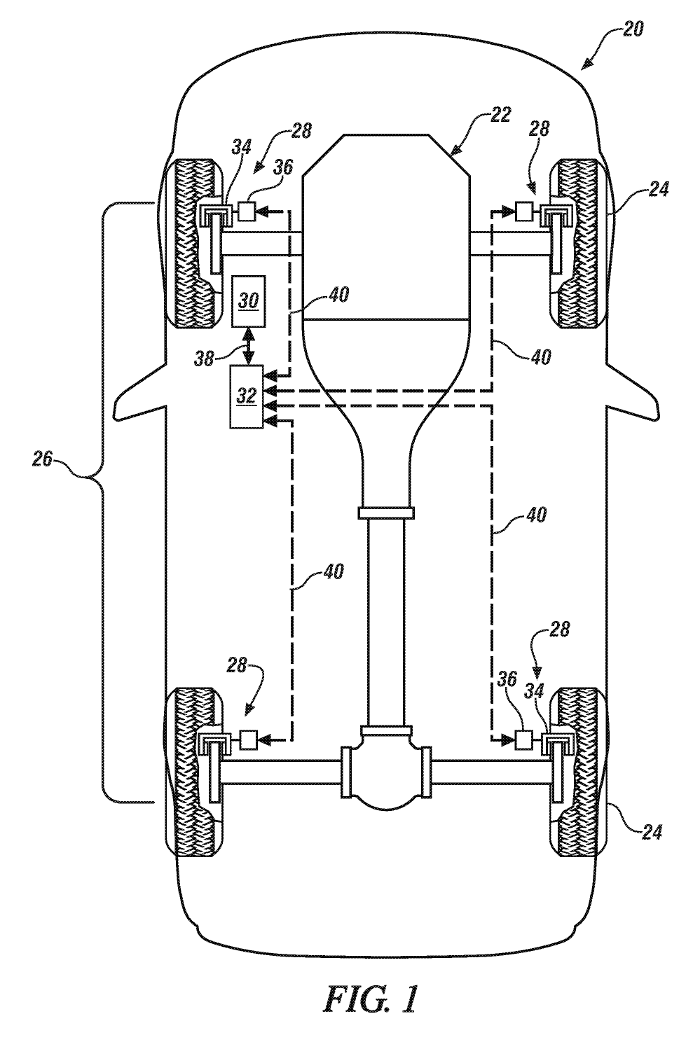

In accordance with an exemplary embodiment of the invention, FIG. 1 is a schematic of a vehicle 20 that may include a powertrain 22 (i.e., an engine, transmission, and differential), a plurality of rotating wheels 24 (i.e., four illustrated), and a braking system 26 that may be a BBW system as one, non-limiting, example. The BBW system 26 may include a brake assembly 28 for each respective wheel 24, a brake pedal apparatus 30, and a controller 32. The powertrain 22 is adapted to drive at least one of the wheels 24 thereby propelling the vehicle 20 upon a surface (e.g., road). The BBW system 26 is configured to generally slow the speed and/or stop motion of the vehicle 20. The vehicle 20 may be an automobile, truck, van, sport utility vehicle, or any other self-propelled or towed conveyance suitable for transporting a burden.

Each brake assembly 28 of the BBW system 26 may include a brake 34 and an actuator 36 configured to operate the brake. The brake 34 may include a caliper (not shown) and may be any type of brake including disc brakes, drum brakes, and others. As non-limiting examples, the actuator 36 may be an electro-hydraulic brake actuator (EHBA) or other actuators capable of actuating the brake 34 based on an electrical input signal that may be received from the controller 32. More specifically, the actuator 36 may be, or may include, any type of motor capable of acting upon a received electric signal and as a consequence, converting energy into motion that controls movement of the brake 34. Thus, the actuator 36 may be a direct current motor configured to generate electro-hydraulic pressure delivered to, for example, the calipers of the brake 34. It is further contemplated and understood that the brake 34 and or the actuator 36 may further include a redundant actuating means that may include more traditional techniques such as a mechanical linkage between the brake 34 and the brake pedal (e.g., push/pull cable, hydraulics, and others).

The controller 32 may include a computer-based processor (e.g., microprocessor) and a computer readable and writeable storage medium. In operation, the controller 32 may receive one or more electrical signals from the brake pedal apparatus 30 over a pathway (see arrow 38) indicative of driver braking intent. In-turn, the controller 32 may process such signals, and based at least in-part on those signals, output an electrical command signal to the actuators 36 over a pathway (see arrow 40). Based on any variety of vehicle conditions, the command signals directed to each wheel 24 may be the same or may be distinct signals for each wheel 24. The pathways 38, 40 may be wired pathways, wireless pathways, or a combination of both.

Non-limiting examples of the controller 32 may include an arithmetic logic unit that performs arithmetic and logical operations; an electronic control unit that extracts, decodes, and executes instructions from a memory; and, an array unit that utilizes multiple parallel computing elements. Other examples of the controller 32 may include an engine control module, and an application specific integrated circuit. It is further contemplated and understood that the controller 32 may include redundant controllers, and/or the system may include other redundancies, to improve reliability of the BBW system 26.

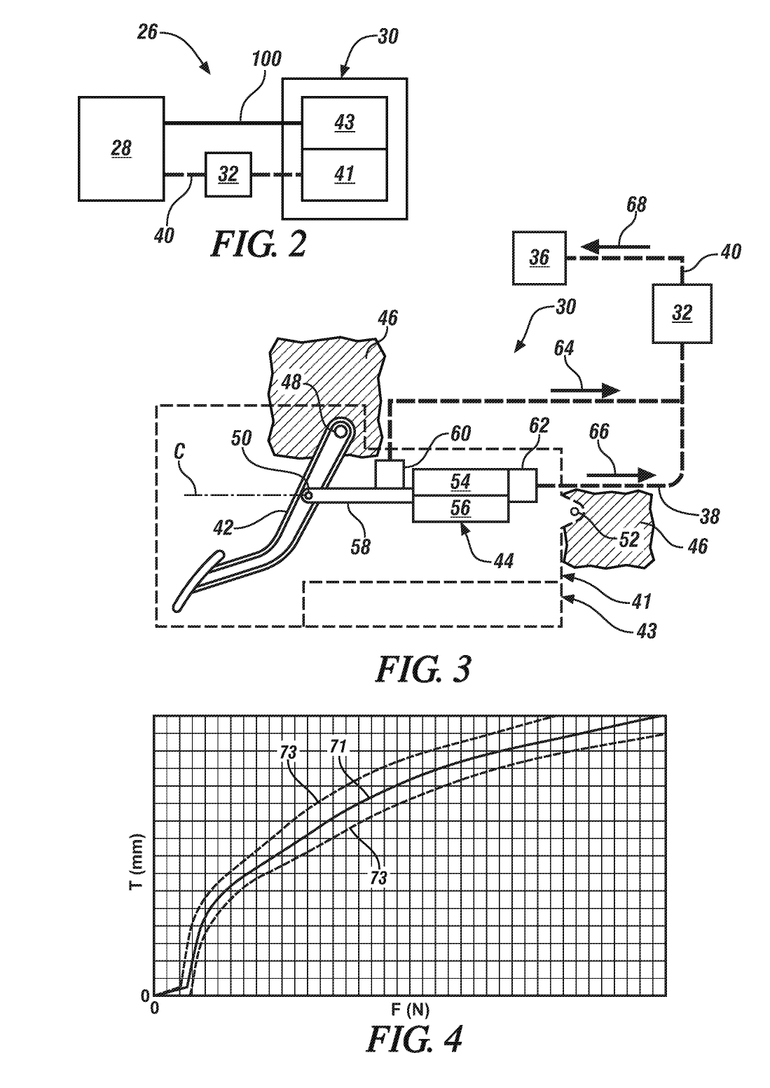

Referring to FIGS. 2 and 3, the brake pedal apparatus 30 of the braking system 26 includes a brake pedal emulator assembly 41, and an emulator override device 43. The brake pedal emulator assembly 41 is configured to simulate the behavior and/or ‘feel’ of a more traditional hydraulic braking system, and includes a brake pedal 42 and a brake pedal emulator 44. The brake pedal 42 is adapted to be actuated by a driver for operating the brake assemblies 28. The brake pedal emulator 44 is adapted to adjust and simulate more traditional brake pedal ‘feel’ (e.g., that of a traditional hydraulic braking system) experienced by the driver. The emulator override device 43 is constructed and arranged, for example, to function as a back-up system if the BBW system 26 is in a faulted state such that the system is no longer able to supply sufficient braking capability.

The brake pedal 42 may be supported by, and in moving relationship too, a fixed structure 46 of the brake pedal apparatus 30. Illustrated as one non-limiting example, the brake pedal 42 may be pivotally engaged to the fixed structure 46 about a first pivot axis 48. The brake pedal emulator 44 may be supported by and extend between the brake pedal 42 and the fixed structure 46. More specifically, the emulator 44 may be pivotally engaged to the brake pedal at a second pivot axis 50, and may be in operable contact with the stationary structure 46 at a contact 52. The second pivot axis 50 may be spaced from and substantially parallel to the first pivot axis 48. It is contemplated and understood that the brake pedal 42 may not be pivotally connected to the stationary structure 46, and instead, may be in sliding contact with the stationary structure with limited degrees of motion. It is further contemplated and understood that the contact 52 may include a third pivotal axis, or may be a sliding contact between the emulator 44 and the stationary structure 46 with limited degrees of motion.

The brake pedal emulator 44 may include a damping device 54 and a force induction device 56 to at least simulate the desired or expected ‘feel’ of the brake pedal 42 during operation by the driver. The damping device 54 is constructed and arranged to generally produce a damping force that is a function of the speed upon which a driver depresses the brake pedal 42. The force induction device 56 produces an induced force (e.g., spring force) that is a function of brake pedal displacement. Both the damping device 54 and the force induction device 56 may be controlled, individually or in combination, by the controller 32 to at least simulate the desired pedal ‘feel.’

One example of the force induction device 56 may be a resiliently compressible, coiled, spring. Other non-limiting examples of a force induction device 56 include elastomeric foam, a wave spring, and any other device capable of producing a variable force generally as a function of brake pedal displacement. One example of the damping device 54 may include a hydraulic cylinder having at least one internal orifice for the flow and exchange of hydraulic fluid between chambers. Such a damping device (and others) may be designed to exert a constant force when a constant speed is applied to the brake pedal throughout the brake pedal throw. One example of such a ‘constant force’ damping device 54 may be a hydraulic cylinder with a single orifice. Another non-limiting example of a damping device 54 may include a device designed to increase a force with increasing pedal displacement and when the brake pedal 42 is depressed at a constant speed. Such ‘variable force’ damping devices may be passive and dependent solely upon the brake pedal position and/or displacement, or may be active and controllable by the controller 32. One example of a ‘passive variable force’ damping device may include a hydraulic cylinder with multiple orifices, sequentially exposed, based on brake pedal position. Other non-limiting examples of a damping device 54 may include a friction damper, and any other device capable of producing a variable force generally as a function of pedal actuation speed. Although illustrated in a parallel (i.e., side-by-side) relationship to one-another, it is further contemplated and understood that the orientation of the devices 54, 56 with respect to one-another may take any variety of forms. For example, the devices 54, 56 may be concentric to one-another along the centerline C (see FIG. 6).

Referring to FIG. 3, the brake pedal emulator 44 may further include a linking member 58 that operatively connects the brake pedal 42 to the devices 54, 56 at the second pivot axis 50. A displacement sensor 60 of the brake pedal emulator 44 may be configured to measure displacement (e.g., linear or angular displacement) of at least one of the brake pedal 42 and the linking member 58. The emulator 44 may further include at least one pressure sensor 62 generally orientated at a reactive side of the devices 54, 56 (i.e., proximate to the contact 52) to measure applied pressure. It is contemplated and understood that the pressure sensor 62 may be a pressure transducer or other suitable pressure sensor configured or adapted to precisely detect, measure, or otherwise determine an applied pressure or force imparted to the brake pedal.

To optimize system reliability, the brake pedal emulator 44 may include more than one displacement sensor located at different locations of the brake pedal apparatus 30. Similarly, the brake pedal emulator 44 may include more than one pressure sensor (i.e., force) configured to, for example, output redundant signals to more than one controller to facilitate fault tolerance for sensor faults.

In operation, the controller 32 is configured to receive a displacement signal (see arrow 64) and a pressure signal (see arrow 66) over pathway 38 and from the respective sensors 60, 62 as the brake pedal 42 is actuated by a driver. The controller 32 processes the displacement and pressure signals 64, 66 then sends appropriate command signal(s) 68 to the brake actuators 36 over the pathway 40. It is contemplated and understood that the signal pathways 38, 40 may be wireless, hard wired, or a combination of both.

Referring to FIG. 4, one example of a force profile of the force induction device 56 is generally illustrated as a function of brake pedal travel T, illustrated in the graph as driver applied brake pedal force F verse the brake pedal travel T. The solid arcuate or curved line 71 represents the targeted profile, and the dashed lines 73 represent the outer bounds (i.e., tolerance) of the targeted profile. The force induction device 56 may be designed to meet this targeted profile 71.

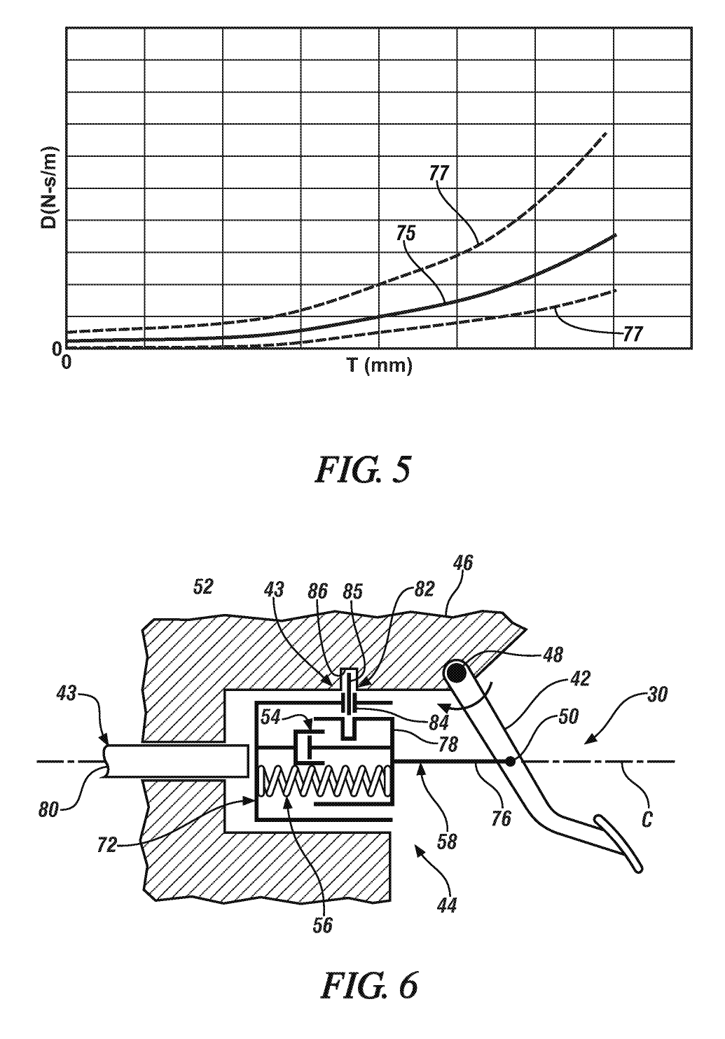

Referring to FIG. 5, one example of a damping coefficient profile is generally illustrated as a function of brake pedal travel T, illustrated in the graph as the brake pedal travel T verse a damping coefficient D. The solid arcuate or curved line 75 represents the targeted profile, and the dashed lines 77 represent the outer bounds (i.e., tolerance) of the targeted profile. Similar to the force induction device 56, the damping device 54 may be designed to meet this targeted profile. It is further contemplated and understood that the data from the targeted force and damping force profiles along with pre-established target tolerances (i.e., bounds) may be programmed into the controller 32 for various processing functions. Although not specifically illustrated, it is further contemplated and understood that to various degrees, one or both of the devices 54, 56 may be adjustable with this adjustability being controlled by the controller 32 to, for example, meet the pre-programmed profiles of FIGS. 4 and 5. It is further noted that the damping coefficient D is a function of pedal position, and the damping force is a function of pedal apply rate and pedal position.

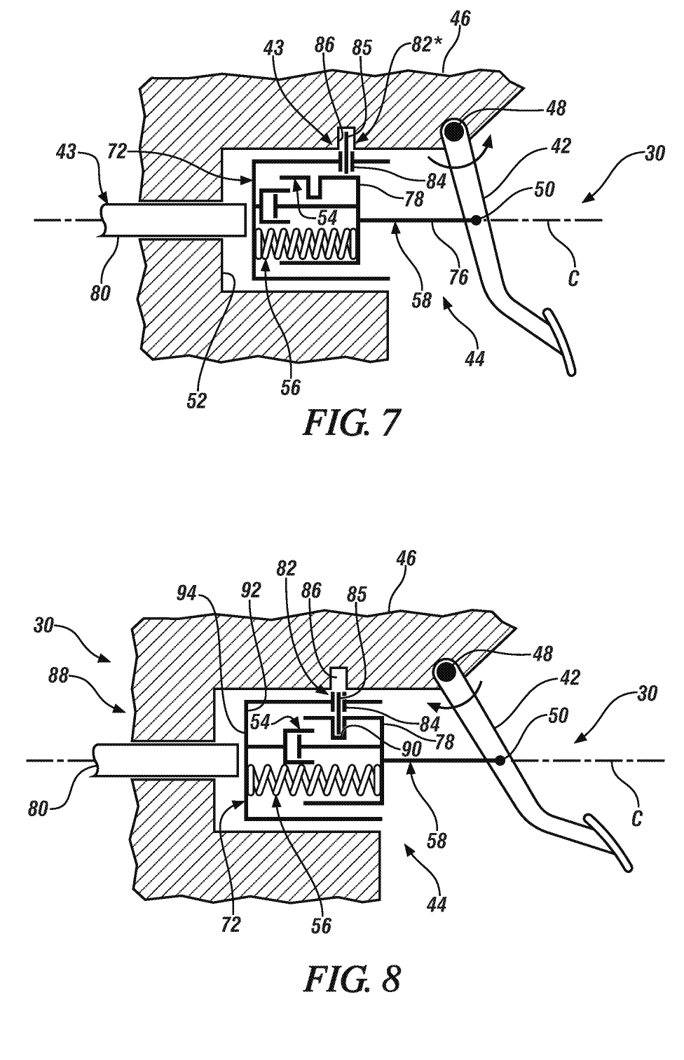

Referring to FIGS. 6 and 7, the brake pedal emulator 44 generally extends along a centerline C and between the brake pedal 42 and, generally, the stationary structure 46 at respective second pivot axis 50 and contact 52. The emulator override device 43 is configured to selectively and mechanically operate the brake assembly 28 via, at least in-part, movement of the brake pedal 42 along the centerline C.

The brake pedal emulator 44 of the brake pedal emulator assembly 41 (also see FIGS. 2 and 3) may further include a base member 72 detachably engaged to the stationary structure 46 when the brake pedal apparatus 30 is in a BBW mode of operation (see FIGS. 6 and 7). The linking member 58 may include a first end portion 76 that may be pivotally engaged directly to the brake pedal 42 at the second pivot axis 50, and an opposite second end portion 78 that may be enlarged. The damping and force induction devices 54, 56 bear upon and extend axially between the base member 72 and the end portion 78 of the linking member 58. As best shown in FIG. 6, when the brake pedal 42 is not actuated and the brake pedal apparatus is in the BBW mode, the damping and force induction devices 54, 56 may be fully extended axially along centerline C. As best shown in FIG. 7, when the brake pedal 42 is substantially fully actuated, the devices 54, 56 may be fully compressed axially. It is further contemplated and understood that the force induction device 56 may also facilitate the return of the brake pedal 42 after the brake pedal is actuated and released by the driver.

The emulator override device 43 of the brake pedal apparatus 30 may include a mechanical linkage 80 (e.g., input rod) and a latch 82. When the brake pedal apparatus 30 is in the BBW mode, the latch 82 generally engages, and holds rigid, the base member 72 to the stationary structure 46. In one embodiment, the latch 82 may include an electric solenoid 84 and a bolt 85 configured to extend and retract from the solenoid based on whether the solenoid is electrically energized or not. The solenoid 84 may be controlled by the controller 32 and may be energized when the brake pedal apparatus 30 is in the BBW mode. In one embodiment, the solenoid 84 may be carried by the base member 72. When the solenoid 84 is energized, the bolt 85 may project from the solenoid and into an opening 86 or other arrangement carried by the stationary structure 46. With the bolt 85 in the opening 86, the base member 72 is prevented from moving (i.e. at least axially along centerline C) with respect to the stationary structure 46, and the devices 54, 56 may be compressed axially between the base member 72 and the linking member 58 which moves axially as the brake pedal 42 is actuated.

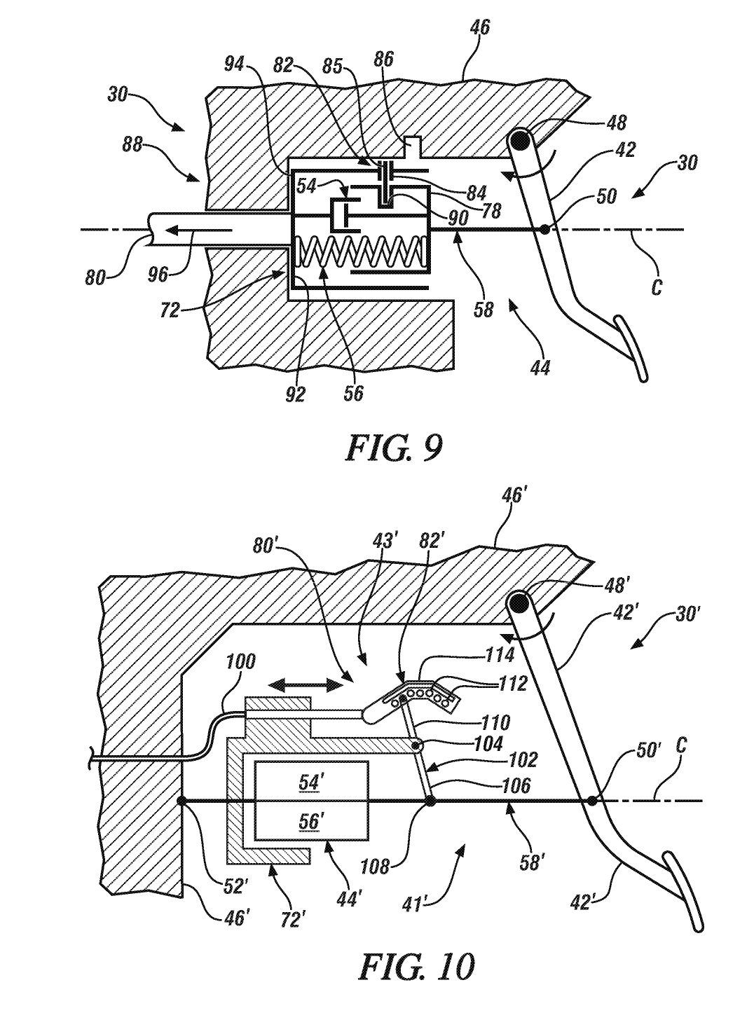

Referring to FIGS. 8 and 9, the brake pedal apparatus 30 is illustrated in a mechanical backup mode 88. When the brake pedal apparatus 30 is in the mechanical backup mode 88 and the brake pedal 42 is not actuated, the damping and force induction devices 54, 56 may be fully extended axially along centerline C (see FIG. 8). As best shown in FIG. 9, during brake pedal 42 actuation and when the brake pedal 42 is substantially fully actuated, the devices 54, 56 remain fully extended and generally do not exert the simulated axial forces upon the brake pedal 42 as previously described during normal operation. Instead, when the brake pedal apparatus 30 is in the mechanical backup mode 88, the electric solenoid 84 of the latch 82 may be de-energized and the bolt 85 may be engaged to the end portion 78 of the linking member 58. In one example and to facilitate this engagement, the bolt 85 may removeably project into a opening 90 in the end portion 78 of the linking member 58. With the latch 82 forming a rigid connection between the base and linking members 72, 58, the members substantially move axially along the centerline C as one piece when the brake pedal 42 is actuated. Furthermore, the base member 72 is no longer engaged (e.g., rigidly or pivotally) to the stationary structure 46, and instead, is in sliding relationship (i.e., the contact 52) to the structure. That is, the structure 46 may facilitate guidance and limit motion of the base member 72 as the base member moves axially with the actuating brake pedal 42. It is further contemplated and understood that the opening 90 may be a series of opening or holes enabling the emulator to lock at a current position if the solenoid is released while the pedal 42 is applied.

The base member 72 may include a first side 92 and an opposite second side 94, both substantially disposed normal to the centerline C. The first side 92 may generally bear upon the damping and force induction devices 54, 56. The second side 94 may bear upon the mechanical linkage 80 of the emulator override device 43. When the brake pedal apparatus 30 is in the mechanical backup mode 88 and the brake pedal 42 is being actuated by the driver, the base and linking members 72, 58 move axially with the pedal 42 causing the second side 94 of the base member 72 to make contact with and move the mechanical linkage 80 in, for example, the axial direction. This motion (see arrow 96 in FIG. 9) of the mechanical linkage 80 is utilized to actuate the brake assembly 28. It is contemplated and understood that the mechanical linkage 80 as illustrated may be, or include, an input or push rod. It is further understood that the mechanical linkage 80 may include other components necessary to mechanically actuate the brake assembly 28 including a hydraulic line, a sheathed (push/pull) cable, a spring (i.e., to provide the necessary force to return the brake pedal 42 after actuation), and other components not illustrated but known to one skilled in the art for more traditional braking systems.

Referring to FIG. 10, a second embodiment of the present invention is illustrated wherein like elements to the first embodiment have like identifying numerals except with the addition of a prime symbol suffix. A brake pedal apparatus 30′ may include a stationary structure 46′, a brake pedal emulator assembly 41′, and an emulator override device 43′. The brake pedal emulator assembly 41′ includes a brake pedal 42′ and a brake pedal emulator 44′. The brake pedal 42′ may be supported by, and in moving relationship too, the stationary structure 46′. Illustrated as one non-limiting example, the brake pedal 42′ may be pivotally engaged to the stationary structure 46′ about a first pivot axis 48′. The brake pedal emulator 44′ may extend between, and is engaged to, the brake pedal 42′ and the stationary structure 46′ at respective second pivot axis 50′ and a contact 52′ that may be a third pivot axis. The brake pedal emulator 44′ may be generally orientated along a centerline C that may intersect the second and third pivot axes 50′, 52′. The pivot axes 48′, 50′, 52′ may be substantially parallel to, and spaced apart from one-another.

The brake pedal emulator 44′ may include a damping device 54′, a force induction device 56′, a linking member 58′, and a base member 72′. The devices 54′, 56′ may be orientated for compression along the centerline C and between the linking and base members 58′, 72′ during normal operation and as the brake pedal 42′ is actuated. The linking member 58′ may be pivotally engaged directly to the brake pedal 42′ at the second pivot axis 50′, and the base member may be pivotally engaged directly to the stationary structure 46′ at the third pivot axis 52′.

The emulator override device 43′ may include a mechanical linkage 80′ and an electric latch 82′ configured to engage and release at least a portion of the mechanical linkage 80′ from the brake pedal emulator 44′. The mechanical linkage 80′ may include a push/pull cable 100 that may be mounted to and/or guided through the base member 72′, and a pivot arm 102 pivotally engaged to the base member at a pivot axis 104. A first end portion 106 of the pivot arm 102 may project radially outward from the pivot axis 104 and may pivotally connect to the linking member 58′ at a pivot axis 108. A second end portion 110, which may be opposite the first end portion 106 (i.e., end portions project in diametrically opposite directions), may carry an electric solenoid (not shown) of the latch 82′. A bolt (not shown) of the latch 82′ may be configured to retract and project, in and out of the solenoid 84′.

When the brake pedal apparatus 30′ is in a mechanical backup mode and the solenoid may be de-energized, the bolt of the latch 82′ may be located in an opening 112 (e.g., hole) defined by an enlarged end segment 114 of the cable 100 that projects out of the base member 72′. With the linking member 58′ thus engaged to the cable 100 of the mechanical linkage 80′, the cable 100 will move with the linking member 58′ and thereby mechanically actuate the brake assembly 28. When the bolt of the latch 82′ is retracted and not in the opening 112, the brake pedal apparatus 30′ is operating normally in BBW mode.

The opening 112 in the enlarged end segment 114 of the cable 100 may be a plurality of openings (e.g., holes) generally aligned side-by-side forming an arcuate pattern that extends substantially axially with respect to the centerline C. The distance between the outer openings along the path may correspond to the total throw (i.e., axial displacement) of the emulator 44′. The multiple openings 112 facilitate actuation of the emulator override device 43′ regardless of the brake pedal position. In this way, the linking member 58′ may continue to move toward the base member 72′, thus compressing the damping and force induction devices 54, 56 even though the BBW mode of operation may not be operative (i.e., the brake assemblies 28 are not receiving a wire brake command).

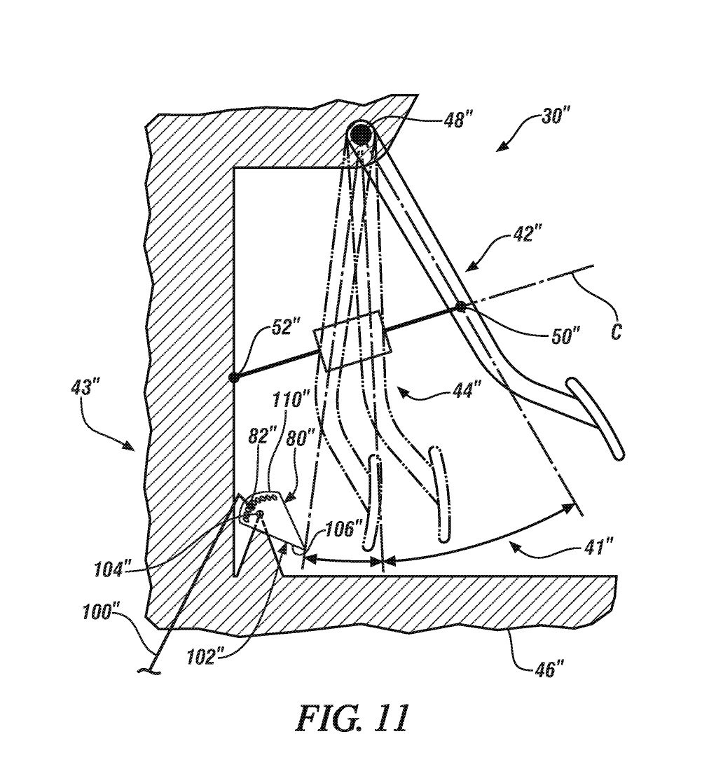

Referring to FIG. 11, a third embodiment of the invention is illustrated wherein like elements to the first and/or second embodiment have like identifying numerals except with the addition of a double prime symbol suffix. A brake pedal apparatus 30″ may include a stationary structure 46″, a brake pedal emulator assembly 41″, and an emulator override device 43″. The brake pedal emulator assembly 41″ includes a brake pedal 42″ and a brake pedal emulator 44″. The brake pedal 42″ may be supported by, and in moving relationship too, the stationary structure 46″. Illustrated as one non-limiting example, the brake pedal 42″ may be pivotally engaged to the stationary structure 46″ about a first pivot axis 48″. The brake pedal emulator 44″ may extend between, and is engaged to, the brake pedal 42″ and the stationary structure 46″ at respective second pivot axis 50″ and a contact 52″ that may be a third pivot axis. The brake pedal emulator 44″ may be generally orientated along a centerline C that may intersect the second and third pivot axes 50′, 52″. The pivot axes 48″, 50″, 52″ may be substantially parallel to, and spaced apart from one-another.

The emulator override device 43″ may include a mechanical linkage 80″ and an electric latch 82″ configured to engage and release at least a portion of the mechanical linkage 80″. The mechanical linkage 80″ may include a pivot arm 102″ pivotally engaged to the stationary structure 46″ at a pivot axis 104″. A first end portion 106″ of the pivot arm 102″ may project radially outward from the pivot axis 104″ for intermittent contact with the brake pedal 42″. A second end portion 110″ having a series of openings (e.g., holes) may be positioned opposite the first end portion 106″. The latch 82″ (e.g., electric solenoid with throw bolt) may be supported by the structure 46″, and may be configured to insert the throw bolt into one of the series of openings in the second end portion 110″.

Advantages and benefits of the present disclosure include a low cost back-up brake system that may automatically override a BBW system if an electric fault is present. Another advantage may include a means for providing a mechanical backup with minimal changes required to a pure BBW emulator. Yet another advantage may include an entire braking system without any need for hydraulic fluid. A further advantage includes an emulator capable of being packaged inline between a master cylinder and a pedal push rod. Yet further, the present disclosure may enable a compact mechanical part envelope that simplifies design and physical integration of a pedal module, along with simplifying diagnosis and servicing of the module.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A brake pedal apparatus for actuating a vehicle brake assembly, the brake pedal apparatus comprising:
a stationary structure;
a brake pedal emulator assembly including a brake pedal operatively engaged to the stationary structure and a brake pedal emulator operatively engaged between the stationary structure and the brake pedal along a centerline, and wherein the brake pedal emulator is configured to electrically operate the brake assembly; and
an emulator override device including a mechanical linkage operatively engaged to the brake assembly and a latch configured to selectively connect and disconnect the mechanical linkage from the brake pedal emulator assembly, and wherein the mechanical linkage is configured to mechanically operate the brake assembly via at least in-part movement of the brake pedal along the centerline.

2. The brake pedal apparatus set forth in claim 1, wherein the latch includes an electric solenoid and a bolt actuated by the electric solenoid to engage and disengage the mechanical linkage.

3. The brake pedal apparatus set forth in claim 2, wherein the bolt is disengaged when the electric solenoid is energized.

4. The brake pedal apparatus set forth in claim 1, wherein the brake pedal is movably connected to the stationary structure, and wherein the brake pedal emulator includes a base member, a linking member engaged to the brake pedal, and a device for exerting an axial force between the base and linking members when the brake pedal is operated.

5. The brake pedal apparatus set forth in claim 4, wherein the device includes a force induction device constructed and arranged to exert a first force of the axial force upon the brake pedal that varies as a function of brake pedal travel, and a damping device constructed and arranged to exert a second force of the axial force upon the brake pedal that varies as a function of at least brake pedal displacement rate.

6. The brake pedal apparatus set forth in claim 4, wherein the latch is releasably engaged between the stationary structure and the base member when the brake pedal apparatus is in a brake-by-wire (BBW) mode, and wherein the latch is releasably engaged between the base member and the linking member when the brake pedal apparatus is in a mechanical backup mode.

7. The brake pedal apparatus set forth in claim 6, wherein the base member is operatively connected to and actuates the mechanical linkage when the brake pedal apparatus is in the mechanical backup mode.

8. The brake pedal apparatus set forth in claim 1, wherein the mechanical linkage includes at least one of a cable, a hydraulic mechanism, and a rod.

9. The brake pedal apparatus set forth in claim 4, wherein the mechanical linkage includes an arm pivotally engaged to the base member, a first end portion mechanically and releasably connected to the brake assembly, and a second end portion pivotally engaged to the linking member.

10. The brake pedal apparatus set forth in claim 9, wherein the latch is carried by the second end portion.

11. The brake pedal apparatus set forth in claim 10, wherein the mechanical linkage includes a push/pull cable having an end segment releasably connected to the second end portion by the latch.

12. The brake pedal apparatus set forth in claim 11, wherein the push/pull cable is supported by the base member.

13. The brake pedal apparatus set forth in claim 12, wherein the latch is releasably engaged between the end segment and the second end portion when the brake pedal apparatus is in a mechanical backup mode, and wherein the latch is released from the end segment when the brake pedal apparatus is in a BBW mode.

14. The brake pedal apparatus set forth in claim 13, wherein the linking member is configured to move axially toward the base member during the mechanical backup mode and when the brake pedal is actuated.

15. A vehicle comprising:
a brake-by-wire (BBW) system including a brake assembly, a brake pedal emulator assembly and an emulator override device, wherein the brake pedal emulator assembly is electrically connected to the brake assembly and the emulator override device is mechanically connected to the brake assembly.

16. The vehicle set forth in claim 15 further comprising:
a fixed structure, wherein the brake pedal emulator assembly includes a brake pedal operatively engaged to the fixed structure and a brake pedal emulator operatively engaged between the fixed structure and the brake pedal along a centerline, and wherein the brake pedal emulator is configured to electrically operate the brake assembly.

17. The vehicle set forth in claim 16, wherein the emulator override device includes a mechanical linkage operatively engaged to the brake assembly and a latch configured to selectively connect and disconnect the mechanical linkage from the brake pedal emulator assembly, and wherein the mechanical linkage is configured to mechanically operate the brake assembly via at least in-part movement of the brake pedal along the centerline.

18. The vehicle set forth in claim 17, wherein the brake pedal emulator includes a base member, a linking member engaged to the brake pedal, and a device for exerting an axial force between the base and linking members when the brake pedal is actuated.

19. The vehicle set forth in claim 18, wherein the latch is releasably engaged between the fixed structure and the base member when the brake pedal apparatus is in a BBW mode, and wherein the latch is releasably engaged between the base member and the linking member when the brake pedal apparatus is in a mechanical backup mode.
